(19) United States
(12) Patent Application Publication
(10) Pub. No.: US 2008/0266546 A1
(43) Pub. Date: Oct. 30, 2008

(54) Device for Analyzing Samples

(75) Inventors: Aleksey Kolesnychenko, Eindhoven (NL); Peter Dirksen, Eindhoven (NL); Yuri Aksenov, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,074

(22) PCT Filed: Dec. 15, 2006
(86) PCT No.: PCT/IB06/54879

§ 371 Date: Jun. 12, 2008

(30) Foreign Application Priority Data
Dec. 15, 2005 (EP) 05112204.2

(51) Int. Cl. G01J 3/00; G01N 21/55

(52) U.S. Cl. 356/51; 356/445

(57) ABSTRACT

The invention relates to a device for analyzing one or more samples for the presence, amount or identity of one or more analytes in the samples, whereby the device comprises a focal microstructure for improving the signal/background ratio of an optical detection of the analytes.

The present invention is directed to the field of devices for the handling and/or detection of one or more analytes in a sample, especially to the field of devices for handling and the detection of biomolecules in solution.

The present invention is directed to the handling and the detection of analytes in samples, especially to the detection of biomolecules in solution. The detection usually occurs in that way, that the fluid to be analyzed is provided on a substrate material, which contains binding substances for the analytes which are subject of the detection. Such a capture probe may be a corresponding DNA-strand in case the analyte is also a DNA-Strand. The analytes in the fluid, which are usually equipped with a label, preferably an optical fluorescence label, will then be captured by the binding substance (in case of two complementary DNA strands this process is called hybridization) and remain there even after the fluid is removed. The analyte may then be detected.

However, in case of optical detection, the resolution of the detection step is somewhat diminished since for a very small volume or amount of analyte in the sample, the signal/noise ratio becomes too small in order to have a proper analysis of the sample.

It is therefore an object of the present invention to provide an analysis device which allows to achieve a better sensitivity.

This object is solved by a device according to claim 1 of the present application.

Accordingly, a device for analyzing one or more samples for the presence, amount or identity of one or more analytes in the samples is provided, whereby the device comprises at least a first material and a second material whereby the first and the second material are so provided towards each other as to form at least one focusing microstructure and the reflection of light with a wavelength of ≧300 nm to ≦800 nm on the focusing microstructure is ≧50%.

By doing so, one or more of the following advantages can be achieved in most applications of the present invention:

due to the concentration of light by the focusing microstructure, the signal/background ratio can for most application be improved dramatically

the device can however, in most applications be kept quite simple avoiding sophisticated designs

an efficient illumination and collection (high NA) provide high sensitivity

a large working distance between detection and bio parts

an easy combination with fluidics

According to an embodiment of the present invention,

(a) the device is provided with at least one binding substance specific for at least one of said analytes

(b) the first and the second material are so provided towards each other as to form at least one focusing microstructure with a focal point in the vicinity of at least one of the binding substance(s).

The term “focal point” in the sense of the present invention especially includes also a “focal volume”, i.e. in case that due to small mistakes in the production of the focal microstructure not all of the light will gather in just one point but rather a volume.

According to a preferred embodiment of the present invention, the reflection of light with a wavelength of ≧300 nm to ≦800 nm on the first microstructure is ≧60%.

Advantageously the reflection of this light on the first microstructure is ≧70%, or ≧80%, or ≧90%, or ≧95%.

Advantageously the reflection of this light on the first microsubstrate is ≧60%, or 70%, or ≧80%, or ≧90%, or 95%.

According to a preferred embodiment of the present invention, the first material has a transparency of ≧50% to ≦99.99% for a light in the wavelength area from ≧300 nm to ≦1000 nm.

The term “transparency” in the sense of the present invention means especially the incident light of a wavelength, which cannot be absorbed by the material, is transmitted through the sample for normal incidence in air.

According to a preferred embodiment of the present invention, the first material has a transparency of ≧50% to ≦99.99% for a light in the wavelength area from ≧400 nm to ≦900 nm.

Advantageously, the first material has a transparency of ≧50% to ≦99.99% for a light in the wavelength area from ≧500 nm to ≦800 nm.

Advantageously, the first material has a transparency of ≧80% to ≦99.99% for a light in the wavelength area from ≧300 nm to ≦1000 nm.

Advantageously, the first material has a transparency of ≧80% to ≦99.99% for a light in the wavelength area from ≧400 nm to ≦900 nm.

Advantageously, the first material has a transparency of ≧80% to ≦99.99% for a light in the wavelength area from ≧500 nm to ≦800 nm.

According to an embodiment of the present invention, the first material is a dielectric material and the index of refraction n₂ of the second material is greater than the index of refraction of the first material n₁ as to fulfill the equation 2≧n₂−n₁≧0.1, according to a further embodiment 1.5≧n₂−n₁≧0.5, according to yet a further embodiment 1.2≧n₂−n₁≧0.8.

According to an embodiment of the present invention, the first material is a metal material.

According to a preferred embodiment of the present invention, the focusing microstructure has a spherical cross-sectional form.

According to a different embodiment of the present invention, the focusing microstructure has an ellipsoidal cross-sectional form.

According to a preferred embodiment of the present invention, at least one of the focal microstructures is provided in the form of a groove.

According to a preferred embodiment of the present invention, at least one of the focal microstructures is provided in the form of an elongated stripe.

It should be noted that in the sense of the present invention the term “stripe” is not limited to somewhat straight structures: according to an embodiment of the present invention, the stripes include bent and/or curved elements.

According to a preferred embodiment, the height:width ratio of the focusing microstructure is ≧0.1:1 and ≦1:1, preferably ≧0.2:1 and ≦0.8:1 and most preferred ≧0.3:1 and ≦0.6:1

According to a preferred embodiment, the focal length:height ratio of the focusing microstructure is ≧1:1 and ≦3:1, preferably ≧1.5:1 and ≦2.5:1 and most preferred ≧1.8:1 and ≦2:1.

In the sense of the present invention, the terms “height” and “width” include the following: Height is the distance between pole of the mirror and a section plane, which is in fact is a chord for obtained circle and width is the length of this chord.

The term “focal length” in the sense of the present invention includes the distance from the focal point of the microstructure to the bottom of the recess in the first material.

According to a preferred embodiment of the present invention, the height of the at least one focal microstructure is ≧0.2 μm to ≦100 μm, preferably ≧1 μm to ≦80 μm, more preferably ≧5 μm to ≦50 μm and most preferred ≧10 μm to ≦30 μm.

According to a preferred embodiment of the present invention, the width of the at least one focal microstructure is ≧2 μm to ≦100 μm, preferably ≧10 μm to ≦80 μm, more preferably ≧20 μm to ≦70 μm and most preferred ≧30 μm to ≦50 μm.

According to a preferred embodiment of the present invention, the device furthermore comprises at least one binding layer and/or binding area provided in the vicinity of the first material. This binding layer and/or binding area may serve e.g. as a basis to link the binding substance to the device (as will be described for a preferred embodiment of the present invention later on).

According to a preferred embodiment of the present invention, the first material is selected out of the group comprising Si, Mo, Ti, TiO, TiN, Al Au, Ag, Cu, organic polymers, preferably selected out of the group comprising polyacrylic acid, poly(meth)-acrylic acid, polyacrylic esters, poly(meth)-acrylic esters, polycarbonates, polystyrene and mixtures thereof, SiO₂ or mixtures thereof.

According to a preferred embodiment of the present invention, the second material is selected out of the group comprising SiO₂, Al₂O₃, HfO, MgF₂ Ta₂O₅ and mixtures thereof.

According to a preferred embodiment of the present invention, the device furthermore comprises a base material. Depending on the material selected for the second material, there are two further preferred embodiments within the present invention:

when the first material is a metal material, it is for some applications preferred that the second material is provided as a layer and the base material is provided in the vicinity of the second material

when the first material is a non-metal material, it is in some applications preferred that the second material serves as the base material.

According to a preferred embodiment of the present invention, the device further comprises at least one light emitting means which emits light towards the focal microstructure and a detecting means for detect the light e.g. emitted by the labeled analyte.

According to an embodiment of the present invention, the at least one light-emitting means is a single-wavelength light emitting means. According to an embodiment of the present invention, the at least one light-emitting means is a laser means.

According to an embodiment of the present invention, the at least one light-emitting means includes means for emitting light at least two different wavelengths.

According to an embodiment of the present invention, the at least one light-emitting means includes means for emitting light with a beam width which is ≧0.8* the width of the focal microstructure.

According to an embodiment of the present invention, the at least one light-emitting means includes means for emitting light which is modulated.

According to an embodiment of the present invention, the modulation includes modulation in amplitude, phase and/or polarization.

According to an embodiment of the present invention, the at least one light-emitting means and the detecting means are synchronized towards each other.

According to an embodiment of the present invention, the device comprises at least one filter and/or polarizer means.

According to an embodiment of the present invention, the filter is a wavelength filter.

According to an embodiment of the present invention, the filter is provided between the light emitting means and the focal microstructure.

According to an embodiment of the present invention, the filter is provided between the detecting means and the focal microstructure.

According to an embodiment of the present invention, the polarizer includes a circular polarizer, a collinear polarizer and/or a quarter-wavelength polarizer.

According to an embodiment of the present invention, the polarizer is provided between the light emitting means and the focal microstructure.

According to an embodiment of the present invention, the polarizer is provided between the detecting means and the focal microstructure.

According to an embodiment of the present invention, the detecting means includes a detecting means which accumulates data in the form of e.g. image, spectrum, sequence of data points.

According to an embodiment of the present invention, the device includes a data processing means which stores and processes the data from the detecting means, preferably together with e.g. the polarization, the modulation and/or the temperature.

According to a preferred embodiment of the present invention, the device further comprises at least one guiding means for guiding the sample, the analytes therein or parts of the sample towards the binding substance(s). According to a preferred embodiment of the present invention, these guiding means comprises a conducting means, preferably metal stripes, which are deposited near the binding substance(s). By applying a voltage between the conducting means an inhomogeneous electrical field is created. It is known that certain analytes can be manipulated by an electrical field. This will allow to bring molecules to the binding site thereby increasing binding efficiency. According to a preferred embodiment of the present invention, the electrical field is modulated. That will move not-binded molecules in the solution allowing lock-in kind of measurement of the fluorescent signal. By doing so, it is in many applications possible to further increase signal to background ratio and allow reliable detection of just a few molecules.

According to an embodiment of the present invention, the device comprises furthermore a temperature controlling and/or adjusting means to control and/or adjust the temperature on or around the focal microstructures and/or within the device.

According to an embodiment of the present invention, the temperature controlling and/or adjusting means serves as to build-up a gradient in temperature with in different focal microstructures and/or within one focal microstructure, e.g. especially when the focal microstructure is provided in form of a stripe.

The present invention furthermore relates to a method of producing a device according to the invention, comprising the steps of:

(a) providing a first material and a second material with an index of refraction n₂, whereby the first and the second material are so provided towards each other as to form at least one focusing microstructure with a focal point

(b) providing at least one binding substance specific for at least one of said analytes

(c) linking the at least one binding substance to the device by emitting light towards the focusing microstructure so that at least a part of the binding substance(s) is linked to the device in the vicinity of the focal point of the focusing microstructure.

Preferably the light used in step (c) is light with a wavelength of ≧200 nm and ≦500 nm. It has been shown in practice that by using light of this wavelength, a good linkage between the microstructure and the binding substance(s) can be achieved. Preferably the light has a wavelength of ≧200 nm and ≦400 nm, more preferred ≧300 nm and ≦400 nm

A device according to the present invention as well as a device as produced with the present method may be of use in a broad variety of systems and/or applications, amongst them one or more of the following:

biosensors used for molecular diagnostics,

rapid and sensitive detection of proteins and nucleic acids in complex biological mixtures such as e.g. blood or saliva,

high throughput screening devices for chemistry, pharmaceuticals or molecular biology,

testing devices e.g. for DNA or proteins e.g. in criminology, for on-site testing (in a hospital), for diagnostics in centralized laboratories or in scientific research,

tools for DNA or protein diagnostics for cardiology, infectious disease and oncology, food, and environmental diagnostics,

tools for combinatorial chemistry,

analysis devices

nano- and micro-fluidic devices.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims, the figures and the following description of the respective figures and examples, which—in an exemplary fashion—show a preferred embodiment of a detector according to the invention.

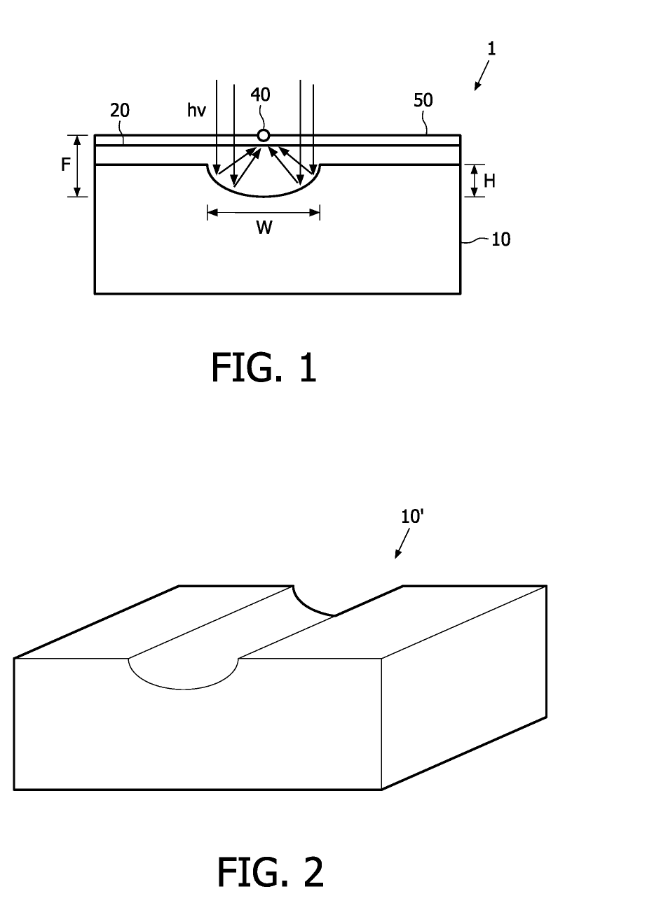

FIG. 1 shows a very schematic cross-sectional view of an assembly of a first and second material according to a first embodiment of the present invention

FIG. 2 shows a perspective view of a second material according to a second embodiment of the present invention

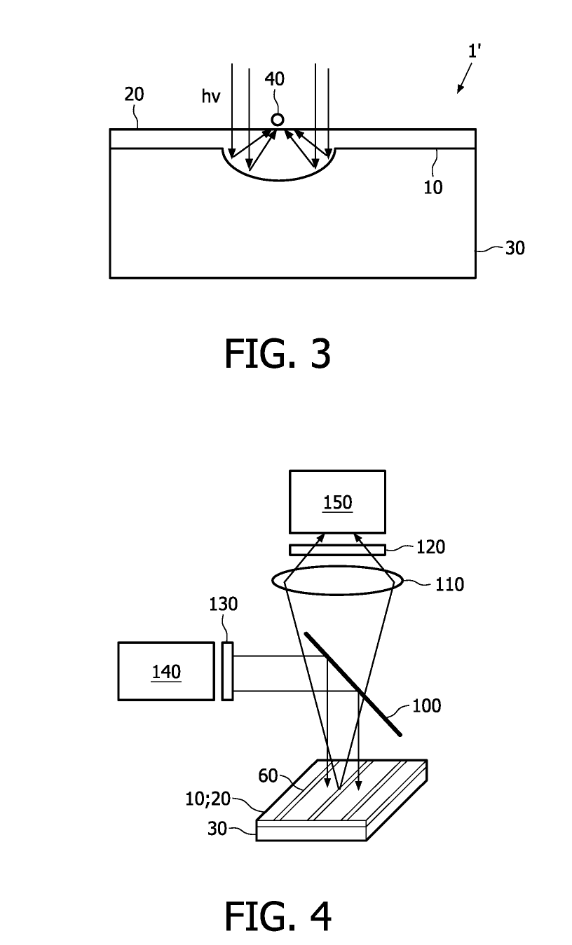

FIG. 3 shows a very schematic cross-sectional view of an assembly of a first, second and a base material according to a third embodiment of the present invention

FIG. 4 shows a very schematic view of a device according to a fourth embodiment of the present invention including light emitting and detecting means.

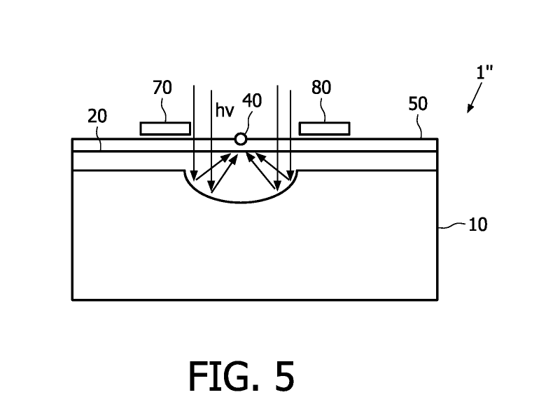

FIG. 5 shows a very schematic cross-sectional view of an assembly of a first and second material together with conducting means according to a fifth embodiment of the present invention

FIG. 1 shows a very schematic cross-sectional view of an assembly 1 of a first and second material 10 and 20 according to a first embodiment of the present invention. As can be seen in FIG. 1, the first and second material 10 and 20 form a focusing microstructure which is somewhat spherical. Incoming light hv will be bent by the focusing microstructure and guided to one of the binding substances 40 which is located in or in close vicinity of the focal point of the microstructure. On top of the first material there is located a binding layer 50, which serves as a set for the binding substance 40. The focal length is indicated by “F” and the height is indicated by “H” of the focal microstructure. The width is indicated by “W”.

FIG. 2 shows a perspective view of a first material 10′ according to a second embodiment of the present invention. As can be seen from FIG. 2, the focal microstructure is somewhat shaped as an elongated pit or groove. However, for some applications it may also be desired that the focal microstructure is formed as (when seen from the top) a circle or ellipsoid.

FIG. 3 shows a very schematic cross-sectional view of an assembly of a first, second and a base material according to a third embodiment of the present invention. This embodiment differs from that of FIG. 1 that the first material is formed as a thin metal layer 10 which is surrounded by a base material 30 on the side which does not project towards the second material 20. It is up to the actual application of the present invention, whether a solution according to this embodiment or to that of FIG. 1 is more advantageous.

FIG. 4 shows a very schematic view of a device according to a fourth embodiment of the present invention including light emitting and detecting means. Here the device is equipped with a light emitting device 140 (e.g. in form of a lamp etc.) which emits light in the form of a parallel or semi parallel beam towards a dichroic mirror 100 towards the focal microstructure 60 (which is very schematically shown) of the first and second material (10;20) which are provided on a base material 30. The emitted light e.g. of the fluorescent labeled bound analytes will be collected by microstructures and than will then pass the mirror 100, be focused by the lens 110 and be detected by the camera 150. Usually the device will also comprise filters 120, 130.

FIG. 5 shows a very schematic cross-sectional view of an assembly 1″ of a first and second material 10 and 20 together with conducting means according to a fifth embodiment of the present invention. In this embodiment, the conducting means 70 and 80 are provided as metal plates on the binding layer 50. In case the second material is shaped as in FIG. 2, the conducting means may simply be stripes which are located left and right of the focal microstructure. By applying a voltage between the stripes it is for many applications possible to direct the sample or analytes in the sample towards the binding substance(s) 40. It should be noted that the conducting means 70 and 80 are shown in a merely exemplarily fashion; in most actual applications they will be much smaller in size.

The particular combinations of elements and features in the above detailed embodiments are exemplary only; the interchanging and substitution of these teachings with other teachings in this are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A device for analyzing one or more samples for the presence, amount or identity of one or more analytes in the samples, whereby the device comprises at least a first material and a second material whereby the first and the second material are so provided towards each other as to form at least one focusing microstructure and the reflection of light with a wavelength of at least 300 nm to at most 800 nm on the focusing microstructure is at least 50 percent

2. A device according to claim 1, whereby
(a) the device is provided with at least one binding substance specific for at least one of said analytes
(b) the first and the second material are so provided towards each other as to form at least one focusing microstructure with a focal point in the vicinity of at least one of the binding substance(s).

3. A device according to claim 1, whereby the focusing microstructure has a spherical or elliptical form.

4. A device according to claim 1, whereby the device furthermore comprises a binding layer provided in the vicinity of the first material.

5. A device according to claim 1 whereby the first material is selected out of the group comprising Si, Mo, Ti, TiO, TiN Al Au, Ag, Cu, organic polymers, preferably selected out of the group comprising polyacrylic acid, poly(meth)-acrylic acid, polyacrylic esters, poly(meth)-acrylic esters, polycarbonates, polystyrene and mixtures thereof, SiO₂ or mixtures thereof.

6. A device according to claim 1 whereby the second material is selected out of the group comprising SiO₂, Al₂O₃, HfO, MgF₂ Ta₂O₅ or mixtures thereof.

7. A device according to claim 1, whereby the height of the at least one focal microstructure is at least 0.2 μm to at most 100 μm, preferably at least 1 μm to at most 80 μm, more preferably at least 5 μm to at most 50 μm and most preferred at least 10 μm to at most 30 μm.

8. A device according to claim 1, whereby the width of the at least one focal microstructure is at least 2 μm to at most 100 μm, preferably at least 10 μm to at most 80 μm, more preferably at least 20 μm to at most 70 μm and most preferred at least 30 μm to at most 50 μm.

9. A device according to claim 1, whereby at least one of the focal microstructures is provided in form of an elongated stripe.

10. A method of producing a device according to claim 1, comprising the steps of:
(a) providing a first material with an index of refraction n₁ and a second material with an index of refraction n₂, whereby the first and the second material are so provided towards each other as to form at least one focusing microstructure with a focal point
(b) providing at least one binding substance specific for at least one of said analytes
(c) linking the at least one binding substance to the device by emitting UV light towards the focusing microstructure so that at least a part of the binding substance(s) is linked to the device in the vicinity of the focal point of the focusing microstructure

11. A system incorporating a device for analyzing one or more samples for the presence, amount or identity of one or more analytes in the samples, whereby the device comprises at least a first material and a second material whereby the first and the second material are so provided towards each other as to form at least one focusing microstructure and the reflection of light with a wavelength of at least 300 nm to at most 800 nm on the focusing microstructure is at least 50 percent, adapted to conduct the method of claim 10 and being used in one or more of the following applications:
biosensors used for molecular diagnostics,
rapid and sensitive detection of proteins and nucleic acids in complex biological mixtures such as e.g. blood or saliva,
high throughput screening devices for chemistry, pharmaceuticals or molecular biology,
testing devices e.g. for DNA or proteins e.g. in criminology, for on-site testing (in a hospital), for diagnostics in centralized laboratories or in scientific research,
tools for DNA or protein diagnostics for cardiology, infectious disease and oncology, food, and environmental diagnostics,
tools for combinatorial chemistry,
analysis devices,
nano- and micro-fluidic devices.
